(19) United States
(12) Patent Application Publication
(10) Pub. No.: US 2022/0300327 A1
(43) Pub. Date: Sep. 22, 2022

(54) METHOD FOR ALLOCATING COMPUTING RESOURCES AND ELECTRONIC DEVICE USING THE SAME

(71) Applicant: PEGATRON CORPORATION, Taipei City (TW)

(72) Inventors: Jia-Shiung Yang, Taipei City (TW); Hsing-Wei Huang, Taipei City (TW)

(73) Assignee: PEGATRON CORPORATION, TAIPEI CITY (TW)

(21) Appl. No.: 17/561,888

(22) Filed: Dec. 24, 2021

(30) Foreign Application Priority Data
Mar. 16, 2021 (TW) 110109278

(51) Int. Cl. G06F 9/50; G06N 20/00; G06F 9/48

(52) U.S. Cl. CPC G06F 9/505; G06N 20/00; G06F 9/4881

(57) ABSTRACT

A method and an electronic device for allocating computing resources are provided. The method includes: accessing a data collection server, a local machine learning (ML) server set, and a first remote ML server set, in which the data collection server stores a training data set; obtaining local traffic information of the local ML server set, and obtaining first traffic information of the first remote ML server set; generating a determined result according to the local traffic information and the first traffic information, and commanding the data collection server to transmit the training data set to one of the local ML server set and the first remote ML server set according to the determined result.

### CROSS-REFERENCE TO RELATED APPLICATION

This application claims the priority benefit of Taiwanese application serial no. 110109278, filed on Mar. 16, 2021. The entirety of the above-mentioned patent application is hereby incorporated by reference herein and made a part of this specification.

### BACKGROUND

### Technical Field

This disclosure relates to a method for allocating computing resources and an electronic device using the method.

### Description of Related Art

With the growing popularity of artificial intelligence technology, many factories are using machine learning technology to perform tasks such as product appearance inspection. Traditionally, each factory can be configured with a dedicated local server. When the sensor acquires sensing data (e.g., images) from the production line, the sensor can send the sensing data to a server to train a machine learning model for recognizing the sensing data. However, when there are multiple factories, many computing resources will be wasted because the computing resources and utilization rates of the servers in each factory are not the same. For example, when the server in factory A is full, the server in factory B may be idle.

In addition, some enterprises use cloud servers to train multiple machine learning models for multiple factories separately. However, the lack of network bandwidth between the factory servers and the cloud servers may lead to a reduction in the efficiency of the training.

### SUMMARY

This disclosure provides a method for allocating computing resources and an electronic device using the method to allocate suitable computing resources to train a machine learning model for training data obtained by a data collection server.

An electronic device for allocating computing resources according to the disclosure is suitable for communicatively connecting to a data collection server, a local machine learning server set, and a first remote machine learning server set. The data collection server stores a training data set and is communicatively connected to the local machine learning server set and the first remote machine learning server set. The electronic device includes a storage medium and a processor. The storage medium stores multiple modules. The processor is coupled to the storage medium, and accesses and executes multiple modules. The modules include a data collection module and an operation module. The data collection module obtains local traffic information of the local machine learning server set and first traffic information of the first remote machine learning server set. The operation module generates a determined result according to the local traffic information and the first traffic information, and commands the data collection server to transmit the training data set to one of the local machine learning server set and the first remote machine learning server set according to the determined result.

According to an embodiment of the disclosure, the local traffic information includes a number of a local server and a number of a local scheduled task corresponding to the local machine learning server set, the first traffic information includes a number of a first server and a number of a first scheduled task corresponding to the first remote machine learning server set, and the operation module calculates a local estimated waiting time according to the number of the local server and the number of the local scheduled task, calculates a first estimated waiting time according to the number of the first server and the number of the first scheduled task, and generates the determined result according to the local estimated waiting time and the first estimated waiting time.

According to an embodiment of this disclosure, the local traffic information includes a local server specification, the first traffic information includes a first server specification, and the operation module calculates a local estimated training time according to a task type of the training data set and the local server specification, calculates a first estimated training time according to the task type and the first server specification, and generates the determined result according to the local estimated training time and the first estimated training time.

According to an embodiment of the disclosure, the data collection server and local machine learning server set are disposed in a local region, the first remote machine learning server set is disposed in a first region different from the local region, the local traffic information includes a transmission resource between the local region and the first region, and the operation module calculates a transmission time according to a size of the training data set and the transmission resource, and generates the determined result according to the transmission time.

According to an embodiment of the disclosure, the operation module commands the data collection server to transmit the training data set to the local machine learning server set in response to the transmission time being greater than a time threshold.

According to an embodiment of the disclosure, the transmission resource includes a data throughput. The operation module commands the data collection server to transmit the training data set to the local machine learning server set in response to the data throughput being greater than a data throughput threshold.

According to an embodiment of the disclosure, the transmission resource includes an available bandwidth. The operation module commands the data collection server to transmit the training data set to the local machine learning server set in response to the available bandwidth being less than or equal to an available bandwidth threshold.

According to an embodiment of this disclosure, the local traffic information further includes a feedback resource between the local region and the first region, and the operation module calculates a feedback time according to a size of a machine learning model corresponding to the first remote machine learning server set and the feedback resource, and generates the determined result according to the feedback time.

According to an embodiment of the disclosure, the operation module calculates a local estimated waiting time and a local estimated training time according to the local traffic information, adds the local estimated waiting time and the local estimated training time to obtain a local indicator, calculates a first estimated waiting time, a first estimated training time, a transmission time, and a feedback time according to the local traffic information and the first traffic information, adds the first estimated waiting time, the first estimated training time, the transmission time, and the feedback time to obtain a first indicator, and generates the determined result according to the local indicator and the first indicator.

According to an embodiment of this disclosure, the electronic device is communicatively connected to a second remote machine learning server set, and the data collection module obtains second traffic information of the second remote machine learning server set. The operation module generates the determined result according to the second traffic information, and commands the data collection server to transmit the training data set to one of the local machine learning server set, the first remote machine learning server set, and the second remote machine learning server set according to the determined result.

A method for allocating computing resources according to the disclosure includes the followings. A data collection server, a local machine learning server set, and a first remote machine learning server set are accessed. The data collection server stores a training data set, and is communicatively connected to the local machine learning server set and the first remote machine learning server set. Local traffic information of the local machine learning server set is obtained, and first traffic information of the first remote machine learning server set is obtained. A determined result according to the local traffic information and the first traffic information is generated, and the data collection server is commanded to transmit the training data set to one of the local machine learning server set and the first remote machine learning server set according to the determined result.

Based on the above, the electronic device according to the disclosure may determine, based on the traffic information, whether the data collection server should transmit collected training data to the local machine learning server set or the remote machine learning server set for training the machine learning model. The disclosure may improve overall computing resource utilization and reduce the time required to train the machine learning model.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic diagram of an electronic device allocating computing resources according to an embodiment of the disclosure.

FIG. 2 illustrates a schematic diagram of allocation of computing resources to multiple regions by an electronic device according to an embodiment of the disclosure.

FIG. 3 illustrates a flowchart of a method for allocating computing resources according to an embodiment of the disclosure.

### DESCRIPTION OF THE EMBODIMENTS

In order to make the contents of this disclosure easier to understand, the following are examples of how this disclosure can indeed be implemented. In addition, where possible, elements/components/steps using the same reference numbers in the drawings and embodiments represent the same or similar parts.

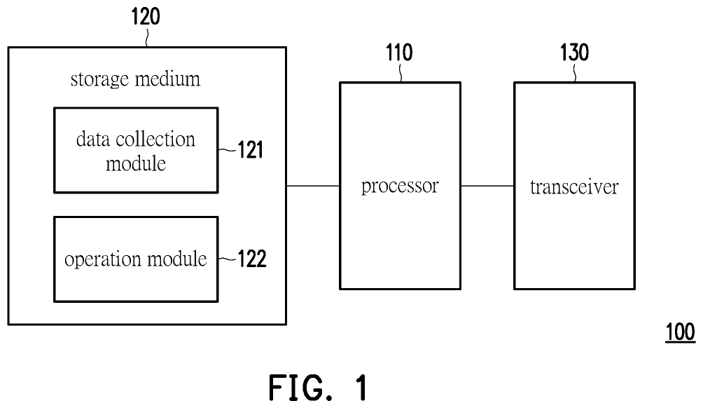

FIG. 1 illustrates a schematic diagram of an electronic device 100 allocating computing resources according to an embodiment of the disclosure. The electronic device 100 may include a processor 110, a storage medium 120, and a transceiver 130.

The processor 110 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP)), image processing unit (IPU), arithmetic logic unit (ALU), complex programmable logic device (CPLD), field programmable gate array (FPGA), or other similar elements or a combination of the elements. The processor 110 may be coupled to the storage medium 120 and the transceiver 130, and access and execute multiple modules and various applications stored in the storage medium 120.

The storage medium 120 is, for example, any type of fixed or removable random access memory (RAM), read-only memory (ROM), flash memory, hard disk drive (HDD), solid state drive (SSD), or similar elements or a combination of the elements, and is used to store the modules or the various applications that may be executed by the processor 110. According to this embodiment, the storage medium 120 may store multiple modules including a data collection module 121 and an operation module 122, the functions of which will be described later.

The transceiver 130 transmits and receives signals by wireless or wired means. The transceiver 130 may also perform operations such as low-noise amplification, impedance matching, mixing, up or down frequency conversion, filtering, amplification, and the like.

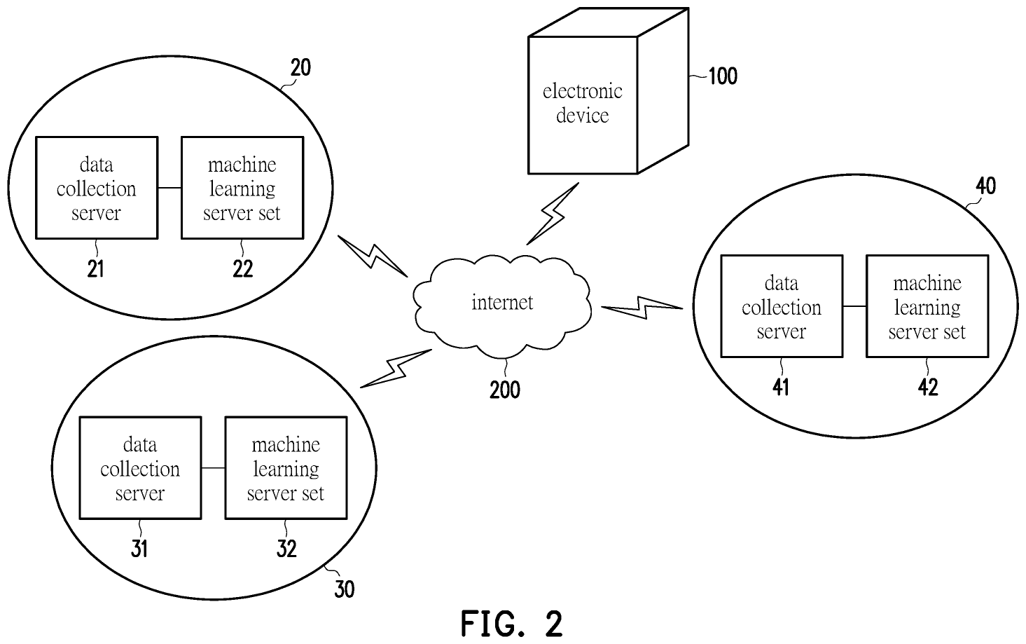

FIG. 2 illustrates a schematic diagram of allocation of computing resources to multiple regions by an electronic device 100 according to an embodiment of the disclosure. According to this embodiment, it is assumed that the regions include three regions such as a region 20, a region 30, and a region 40, but the disclosure is not limited thereto. For example, a number of the regions may be any positive integer greater than or equal to two. The region is, for example, a factory floor. If two devices are disposed in a same region, it means that the two devices are geographically close to each other, or that the two devices may communicate with each other through a local area network (LAN).

Each of the regions is provided with a dedicated data collection server and a machine learning server set. Specifically, the region 20 may be provided with a data collection server 21 and a machine learning server set 22. The data collection server 21 may be coupled to the machine learning server set 22, and the data collection server 21 may obtain and store a training data set for training a machine learning model corresponding to the region 20. For example, the data collection server 21 may be communicatively connected to one or more sensors disposed in the region 20, and obtain a sensing data set from the one or more sensors. The data collection server 21 may store the obtained sensing data set as a training data set. Similarly, the region 30 may be provided with a data collection server 31 and a machine learning server set 32. The data collection server 31 may be coupled to the machine learning server set 32, and the data collection server 31 may obtain and store a training data set for training a machine learning model corresponding to the region 30. The region 40 may be provided with a data collection server 41 and a machine learning server set 42. The data collection server 41 may be coupled to the machine learning server set 42, and the data collection server 41 may obtain and store a training data set for training a machine learning model corresponding to the region 40.

The electronic device 100 may be connected to the each of the regions through a network 200, and one region may be connected to another region through the network 200. The network 200 is, for example, a wide area network (WAN). According to one embodiment, the electronic device 100 may be disposed in the region 20 (or the regions 30, 40) and be communicatively connected to an electronic device (for example, the data collection server 21 or the machine learning server set 22) in the region 20 through the local area network (LAN). Taking the region 20 as an example, the data collection server 21 in the region 20 may be connected to the electronic device 100, the data collection server 31, and the data collection server 41 through the network 200. In addition, the data collection server 21 may communicate with the machine learning server set 32 through the data collection server 31, and may communicate with the machine learning server set 42 through the data collection server 41.

According to the following embodiment, the machine learning server set 22 is used as a local machine learning server set, the machine learning server set 32 or the machine learning server set 42 is used as a remote machine learning server set, the electronic device 100 may allocate computing resources to the training data set, and the training data set is collected by the data collection server 21.

The electronic device 100 may calculate multiple parameters corresponding to the machine learning server sets 22, 32, and 42, respectively, for the data collection server 21 according to a traffic information, and obtain multiple indicators corresponding to the machine learning server sets 22, 32, and 42, respectively, according to the parameters, to generate a determined result. The determined result may command the data collection server 21 to transmit the training data set to one of the machine learning server sets 22, 32, and 42. Specifically, the data collection module 121 of the electronic device 100 may access the network 200 through the transceiver 130 to obtain local traffic information, first traffic information, and second traffic information corresponding to the machine learning server sets 22, 32, and 42, respectively. The operation module 122 may generate a determined result according to the local traffic information, the first traffic information, and the second traffic information.

According to one embodiment, the local traffic information corresponding to the machine learning server set 22 may include a number of servers of the machine learning server set 22 and a number of scheduled tasks. The operation module 122 may calculate an estimated waiting time T(WA) according to the number of the servers and the number of the scheduled tasks. If the data collection server 21 transmits the training data set to the machine learning server set 22, the machine learning server set 22 needs to wait for the estimated waiting time T(WA) before starting to train the machine learning model according to the training data set. Similarly, the first traffic information corresponding to the machine learning server set 32 may include a number of servers of the machine learning server set 32 and a number of scheduled tasks. The operation module 122 may calculate an estimate waiting time T(WB) according to the number of the servers and the number of the scheduled tasks. If the data collection server 21 transmits the training data set to the machine learning server set 32, the machine learning server set 32 needs to wait for the estimated waiting time T(WB) before starting to train the machine learning model according to the training data set. The second traffic information corresponding to the machine learning server set 42 may include a number of servers of the machine learning server set 42 and a number of scheduled tasks. The operation module 122 may calculate an estimated waiting time T(WC) according to the number of the servers and the number of the scheduled tasks. If the data collection server 21 transmits the training data set to the machine learning server set 42, the machine learning server set 42 needs to wait for the estimated waiting time T(WC) before starting to train the machine learning model according to the training data set.

The operation module 122 may generate a determined result according to the estimated waiting time T(WA), the estimated waiting time T(WB), and the estimated waiting time T(WC). The operation module 122 may determine the training data set to be sent to the machine learning server set corresponding to a minimum estimated waiting time. For example, if the estimated waiting time T(WA) is less than the estimated waiting time T(WB), and the estimated waiting time T(WB) is less than the estimated waiting time T(WC), the operation module 122 may command the data collection server 21 to transmit the training data set to the machine learning server set 22 in response to the estimated wait time T(WA) being the minimum estimated wait time.

According to one embodiment, the local traffic information corresponding to the machine learning server set 22 may include a server specification of the machine learning server set 22 (for example, CPU model, storage space, memory or data transmission bandwidth, etc.). The operation module 122 may calculate an estimated training time T(TA) according to a task type of the training data set of the data collection server 21 and the server specification. If the data collection server 21 transmits the training data set to the machine learning server set 22, the machine learning server set 22 needs to spend the estimated training time T(TA) in training the machine learning model. Similarly, the first traffic information corresponding to the machine learning server set 32 may include a server specification of the machine learning server set 32. The operation module 122 may calculate an estimated training time T(TB) according to the task type of the training data set of the data collection server 21 and the server specification. If the data collection server 21 transmits the training data set to the machine learning server set 32, the machine learning server set 32 needs to spend the estimated training time T(TB) in training the machine learning model. The second traffic information corresponding to the machine learning server set 42 may include a server specification of the machine learning server set 42. The operation module 122 may calculate an estimated training time T(TC) according to the task type of the training data set of the data collection server 21 and the server specification. If the data collection server 21 transmits the training data set to the machine learning server set 42, the machine learning server set 42 needs to spend the estimated training time T(TC) in training the machine learning model.

The task type may be related to algorithm of the machine learning model. For example, if the task type corresponds to machine learning algorithm A and the machine learning algorithm A consumes more computing resources in training the machine learning model, the estimated training time calculated by the operation module 122 will be longer. If the task type corresponds to machine learning algorithm B and the machine learning algorithm B consumes less computing resources in training the machine learning model, the estimated training time calculated by the operation module 122 will be shorter.

The operation module 122 may generate a determined result according to the estimated training time T(TA), the estimated training time T(TB), and the estimated training time T(TC). The operation module 122 may decide to transmit the training data set to the machine learning server set corresponding to a minimum estimated training time. For example, if the estimated training time T(TC) is less than the estimated training time T(TB), and the estimated training time T(TB) is less than the estimated training time T(TC), the operation module 122 may command the data collection server 21 to transmit the training data set to the machine learning server set 22 in response to the estimated training time T(TA) being the minimum estimated training time.

According to one embodiment, the first traffic information corresponding to the machine learning server set 32 may include a transmission resource between the region 20 and the region 30. More specifically, the first traffic information may include a transmission resource (e.g., downlink bandwidth) between the data collection server 21 and the data collection server 31. The operation module 122 may calculate a transmission time T(DB) according to a size of the training data set and the transmission resource. If the data collection server 21 transmits the training data set to the machine learning server set 32, the data collection server 21 needs to spend the transmission time T(DB) to transmit the training data set to the data collection server 31, which in turn forwards the training data set to the machine learning server set 32. Similarly, the second traffic information corresponding to the machine learning server set 42 may include a transmission resource between the region 20 and the region 40. More specifically, the second traffic information may include a transmission resource between the data collection server 21 and the data collection server 41. The operation module 122 may calculate s transmission time T(DC) according to the size of the training data set and the transmission resource. If the data collection server 21 transmits the training data set to the machine learning server set 42, the data collection server 21 needs to spend the transmission time T(DC) to transmit the training data set to the data collection server 41, which in turn forwards the training data set to the machine learning server set 42.

The operation module 122 may generate a determined result according to the transmission time T(DB) and the transmission time T(DC). The operation module 122 may decide to transmit the training data set to the machine learning server set corresponding to a minimum transmission time. For example, if the operation module 122 intends to command the data collection module 121 to transmit the training data set to one of the machine learning server set 32 and the machine learning server set 42, the operation module 122 may command the data collection module 121 to transmit the training data set to the machine learning server set 32 in response to the transmission time T (DB) being less than the transmission time T(DC).

If the training data set of the data collection server 21 is confidential, the operation module 122 may configure the transmission time T(DB) to a default maximum value to avoid the data collection server 21 from transmitting the training data set to the machine learning server set 32 located in a different region. Similarly, if the training data set is confidential, the operation module 122 may configure the transmission time T(DC) to a default maximum value to avoid the data collection server 21 from transmitting the training data set to the machine learning server set 42 located in a different region.

If the transmission time T(DB) is greater than a time threshold, the operation module 122 will prevent the training data set of the data collection server 21 from being transmitted to the machine learning server set 32. For example, if the operation module 122 can instruct the data collection server 21 to send the training data set to one of the machine learning server set 22 and the machine learning server set 32, the operation module 122 can respond to the transmission time T (DB) is greater than the time threshold and instructs the data collection server 21 to send the training data set to the machine learning server set 22.

The transmission resource between the data collection server 21 and the data collection server 31 may include a data throughput. If the data throughput is greater than a data throughput threshold, the operation module 122 will avoid the training data set from being transmitted to the machine learning server set 32. For example, if the operation module 122 intends to transmit the training data set to one of the machine learning server set 22 and the machine learning server set 32, the operation module 122 may command the data collection server 21 to transmit the training data set to the machine learning server set 22 in response to the data throughput being greater than the data throughput threshold.

The transmission resource between the data collection server 21 and the data collection server 31 may include an available bandwidth. If the available bandwidth is less than or equal to an available bandwidth threshold, the operation module 122 will avoid the training data set from being transmitted to the machine learning server set 32. For example, if the operation module 122 intends to transmit the training data set to one of the machine learning server set 22 and the machine learning server set 32, the operation module 122 may command the data collection server 21 to transmit the training data set to the machine learning server set 22 in response to the available bandwidth between the data collection server 21 and the data collection server being less than or equal to the available bandwidth threshold.

The transmission resource between the data collection server 21 and the data collection server 31 may include a feedback resource (e.g., uplink bandwidth). After the machine learning server set 32 completes training the machine learning model, the data collection server 31 may transmit the machine learning model back to the data collection server 21 through the transmission resource. The operation module 122 may calculate a feedback time T(MB) according to a size of the machine learning model and the feedback resource. The data collection server 31 needs to spend the feedback time T(MB) to transmit the machine learning model back to the data collection server 21. Similarly, a transmission resource between the data collection server 21 and the data collection server 41 may include a feedback resource. After the machine learning server set 42 completes training the machine learning model, the data collection server 41 may transmit the machine learning model back to the data collection server 21 through the transmission resource. The operation module 122 may calculate a feedback time T(MC) according to the size of the machine learning model and the feedback resource. The data collection server 41 needs to spend the feedback time T(MC) to transmit the machine learning model back to the data collection server 21.

The operation module 122 may generate a determined result according to the feedback time T(MB) and the feedback time T(MC). The operation module 122 may decide to transmit the training data set to the machine learning server set corresponding to a minimum feedback time. For example, if the operation module 122 intends to transmit the training data set to one of the machine learning server set 32 and the machine learning server set 42, the operation module 122 may command the data collection server 21 to transmit the training data set to the machine learning server set 32 in response to the feedback time T(MB) being less than the feedback Time T(MC).

According to one embodiment, to determine to which machine learning server set the training data set collected by the data collection server 21 is to be transmitted, the operation module 122 may generate a determined result according to a sum of any two or more of the parameters of the estimated waiting time, the estimated training time, the transmission time, and the feedback time based on machine learning requirements. According to one embodiment, the operation module 122 may aggregate all of the estimated waiting time, the estimated training time, the transmission time, and/or the time to respectively obtain an indicator I(A) corresponding to the machine learning server set 22, an indicator I(B) corresponding to the machine learning server set 32, and an indicator I(C) corresponding to the machine learning server set 42. The operation module may generate a determined result according to the indicator I(A), the indicator I(B), and the indicator I(C). The determined result may command the data collection server 21 to transmit the training data set to one of the machine learning server set 22, the machine learning server set 32, and the machine learning server set 42. The operation module 122 may calculate the indicator I(A), the indicator I(B), and the indicator I(C) according to equations (1) to (3) shown below.

I(A)=T(WA)+T(TA) (1)

I(B)=T(WB)+T(TB)+T(DB)+T(MB) (2)

I(C)=T(WC)+T(TC)+T(DC)+T(MC) (3)

The smaller the value of the indicator, the less time it takes to train the machine learning model. Therefore, the operation module 122 may decide to transmit the training data set to the machine learning server set corresponding to a smallest indicator. For example, the operation module 122 may command the data collection server 21 to transmit the training data set to the machine learning server set 22 in response to the indicator I(A) being the smallest indicator of the three indicators.

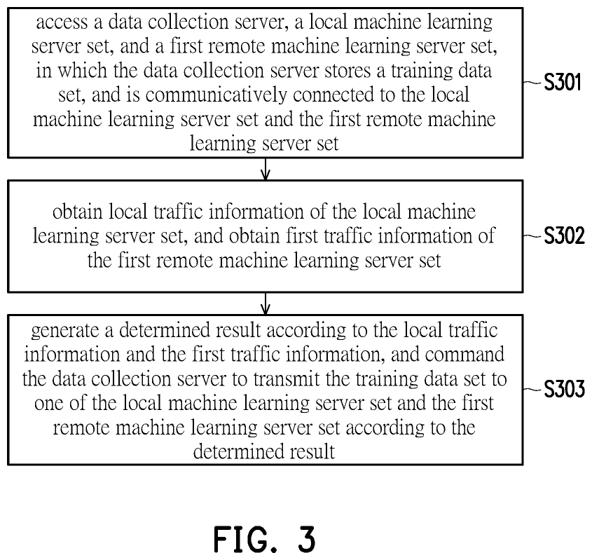

FIG. 3 illustrates a flowchart of a method for allocating computing resources according to an embodiment of the disclosure, in which the method may be implemented by the electronic device 100 shown in FIG. 1. According to step S301, a data collection server, a local machine learning server set, and a first remote machine learning server set are accessed. The data collection server stores a training data set, and is communicatively connected to the local machine learning server set and the first remote machine learning server set. According to step S302, local traffic information of the local machine learning server set is obtained, and first traffic information of the first remote machine learning server set is obtained. According to step S303, a determined result is generated according to the local traffic information and the first traffic information, and the data collection server is commanded to transmit the training data set to one of the local machine learning server set and the first remote machine learning server set according to the determined result.

In summary, the electronic device disclosed in this disclosure may be communicatively connected to data collection servers and machine learning servers in the each of the regions, and obtain relevant information from the servers to calculate information such as the estimated waiting time, the training time, the transmission time, or the feedback time. The electronic device may determine, based on each of the parameters, whether the data collection server should transmit the collected training data to the local machine learning server set or the remote machine learning server set for training the machine learning model. In general, the electronic device may command the data collection server to transmit the training data to a local machine learning server set that is closer to the data collection server. However, when the local machine learning server set is busy, the electronic device may command the data collection server to transmit the training data to a remote machine learning server set that is farther away from the data collection server. Accordingly, the disclosure may increase efficiency of computing resources and minimize a generation time of the machine learning model.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device for allocating computing resources, suitable for communicatively connecting to a data collection server, a local machine learning server set, and a first remote machine learning server set, wherein the data collection server stores a training data set and is communicatively connected to the local machine learning server set and the first remote machine learning server set, and the electronic device comprises:
a storage medium storing a plurality of modules; and
a processor coupled to the storage medium, and accessing and executing the modules, wherein the modules comprises:
a data collection module obtaining local traffic information of the local machine learning server set and first traffic information of the first remote machine learning server set; and
an operation module generating a determined result according to the local traffic information and the first traffic information, and commanding the data collection server to transmit the training data set to one of the local machine learning server set and the first remote machine learning server set according to the determined result.

2. The electronic device according to claim 1, wherein the local traffic information comprises a number of a local server and a number of a local scheduled task corresponding to the local machine learning server set, the first traffic information comprises a number of a first server and a number of a first scheduled task corresponding to the first remote machine learning server set, and the operation module calculates a local estimated waiting time according to the number of the local server and the number of the local scheduled task, calculates a first estimated waiting time according to the number of the first server and the number of the first scheduled task, and generates the determined result according to the local estimated waiting time and the first estimated waiting time.

3. The electronic device according to claim 1, wherein the local traffic information comprises a local server specification, the first traffic information comprises a first server specification, and the operation module calculates a local estimated training time according to a task type of the training data set and the local server specification, calculates a first estimated training time according to the task type and the first server specification, and generates the determined result according to the local estimated training time and the first estimated training time.

4. The electronic device according to claim 1, wherein the data collection server and the local machine learning server set are disposed in a local region, the first remote machine learning server set is disposed in a first region different from the local region, the local traffic information comprises a transmission resource between the local region and the first region, and the operation module calculates a transmission time according to a size of the training data set and the transmission resource, and generates the determined result according to the transmission time.

5. The electronic device according to claim 4, wherein the operation module commands the data collection server to transmit the training data set to the local machine learning server set in response to the transmission time being greater than a time threshold.

6. The electronic device according to claim 4, wherein the transmission resource comprises a data throughput, wherein the operation module commands the data collection server to transmit the training data set to the local machine learning server set in response to the data throughput being greater than a data throughput threshold.

7. The electronic device according to claim 4, wherein the transmission resource comprises an available bandwidth, wherein the operation module commands the data collection server to transmit the training data set to the local machine learning server set in response to the available bandwidth being less than or equal to an available bandwidth threshold.

8. The electronic device according to claim 4, wherein the local traffic information further comprises a feedback resource between the local region and the first region, and the operation module calculates a feedback time according to a size of a machine learning model corresponding to the first remote machine learning server set and the feedback resource, and generates the determined result according to the feedback time.

9. The electronic device according to claim 1, wherein the operation module calculates a local estimated waiting time and a local estimated training time according to the local traffic information, adds the local estimated waiting time and the local estimated training time to obtain a local indicator, calculates a first estimated waiting time, a first estimated training time, a transmission time, and a feedback time according to the local traffic information and the first traffic information, adds the first estimated waiting time, the first estimated training time, the transmission time, and the feedback time to obtain a first indicator, and generates the determined result according to the local indicator and the first indicator.

10. The electronic device according to claim 1, wherein the electronic device is communicatively connected to a second remote machine learning server set, and the data collection module obtains second traffic information of the second remote machine learning server set, wherein the operation module generates the determined result according to the second traffic information, and commands the data collection server to transmit the training data set to one of the local machine learning server set, the first remote machine learning server set, and the second remote machine learning server set according to the determined result.

11. A method for allocating computing resources comprising:
accessing a data collection server, a local machine learning server set, and a first remote machine learning server set, wherein the data collection server stores a training data set, and is communicatively connected to the local machine learning server set and the first remote machine learning server set;
obtaining local traffic information of the local machine learning server set, and obtaining first traffic information of the first remote machine learning server set; and
generating a determined result according to the local traffic information and the first traffic information, and commanding the data collection server to transmit the training data set to one of the local machine learning server set and the first remote machine learning server set according to the determined result.
